(19) United States
(12) Patent Application Publication
(10) Pub. No.: US 2016/0229561 A1
(43) Pub. Date: Aug. 11, 2016

(54) END-EFFECTOR BODY FOR A FIXTURE DEVICE

(71) Applicant: SAAB AB, Linköping (SE)

(72) Inventor: Mats Enmar, Vreta Kloster (SE)

(21) Appl. No.: 15/022,279

(22) PCT Filed: Sep. 16, 2013
(86) PCT No.: PCT/SE2013/051075

§ 371 Date: Mar. 16, 2016

(51) Int. Cl. B64F 5/00; B25B 11/02

(52) U.S. Cl. CPC B64F 5/0009; B25B 11/02

(57) ABSTRACT

An end-effector body for a fixture device. The end-effector body includes a first fixing point, a second fixing pint and a third fixing pint for attachment to an article. The fixing points are arranged to face away from the end-effector body in different directions. Also, an adjustable fixture device including an end-effector body.

### TECHNICAL FIELD

The present invention relates to an end-effector body for a fixture device according to the preamble of claim 1 and an adjustable fixture device comprising such end-effector body according to claim 11.

The invention relates generally to the aeronautical industry and specifically to the manufacturing and/or assembly of aeronautic structures.

### BACKGROUND ART

In the aeronautical industry, fixtures are commonly used to hold and fixate articles while they are being machined or assembled. Large frameworks are often used onto which the fixture arrangements are mounted in order to hold the article in place. The fixtures can either be designed and manufactured for each specific process and be shimmed in place on the framework, or the fixtures can be adjustable and reconfigurable and be used on several occasions. In either case, the fixture comprises means for engaging and holding the article, such as an end-effector or a pickup. The use of fixtures that are manufactured and adapted to each individual process is expensive and time-consuming and the use of adjustable and flexible fixtures is becoming more common. A known adjustable fixture on the market comprises a base plate and a top plate with multiple legs joining the base plate and the top plate. The legs have a universal joint in each end and each leg length can be changed by a telescopic movement. This previously known adjustable fixture also comprises an end-effector, which is arranged on the top plate for engagement with the article. This previously known adjustable fixture is flexible in that it can be used on different positions to hold an article from different directions by adjusting and tilting the legs and thus arrange the end-effector aligned with the article. The tilting of the fixture and thus the end-effector is however time consuming and the legs take up a lot of space when tilted. Also, the fixture is less rigid and steady when the legs are tilted.

The object of the present invention is to provide an end-effector body, which is flexible, such that it can be used to hold an article from different directions.

Another object of the invention is to provide an end-effector body, which is compact and space-saving.

Another object of the invention is to provide an end-effector body, which is user friendly.

Another object of the invention is to provide an adjustable fixture device, which is steady, has a high resistance and is compact and space-saving.

Another object of the invention is to provide a production line, which is effective and flexible.

The foregoing and other objects and advantages of the present invention will be apparent to those skilled in the art, in view of the following detailed description, taken in conjunction with the appended claims and the accompanying drawings.

### SUMMARY OF THE INVENTION

The objects of the invention have been achieved by the end-effector body defined in the introduction and characterized by the features of the characterizing part of claim 1.

By providing the end-effector body with a first and a second fixing point for attachment to an article, which fixing points are arranged to face away from the end-effector body in different directions, the end-effector body can engage with the article in different directions, one at a time, essentially without having to tilt the end-effector body. This way, the same end-effector body can be used to hold an article from different directions without time consuming adjustments and can thereby easily be used on different positions in a production line. The end-effector may, for example first be arranged at a position holding an article from underneath and then be moved to another position holding the same article from the side, using the two different fixing points respectively and without tilting the end-effector body. The end-effector may also be moved from a position holding a first article from the side using one of the fixing points, to another position holding a second article from underneath using the other fixing point. This way is achieved an end-effector body, which is flexible to use.

Tilting of the end-effector body commonly involves tilting of a fixture device comprising the end-effector, such as tilting of a support means to which the end-effector is attached. In cases where the end-effector body according to the present invention is arranged on an adjustable fixture device, for example an adjustable fixture device comprising adjustable legs according to prior art, no tilting of the legs is needed. The adjustable fixture device can thereby be positioned in a steady position where it does not take up a lot of space. Thus is achieved an adjustable fixture device which is steady, has a high resistance and which is compact and space-saving.

Preferably, the first and second fixing points are arranged such that they face away from the end-effector body in two different directions forming an angle there between, wherein the angle is between 40-90 degrees, preferably 90 degrees.

Suitably, the first fixing point and the second fixing point of the end-effector body are arranged such that they face away from the end-effector body in directions intersecting each other at an angle between 40-90 degrees, preferably 90 degrees.

The first and second fixing points are preferably arranged such that they face away from the end-effector body in directions diverging away from the end-effector body.

The direction, in which a fixing point faces away from the end-effector body, is defined as an imagined straight line.

The first fixing point is suitably provided at a first surface of the end-effector body and the second fixing point is preferably provided at a second surface of the end-effector body, arranged at an angle to the first surface. The first and the second surface are preferably arranged such that an angle is formed between the respective normal of the first surface and the second surface, wherein the angle is between 40-90 degrees, preferably 90 degrees.

The second surface of the end-effector body is preferably extending perpendicularly to the extension of the first surface. This way, the end-effector body can be arranged in a position where it can hold an article from underneath or from above by preferably using the first fixing point or it can be arranged in a position to hold an article from the side by preferably using the second fixing point, without tilting the end-effector body.

Preferably, when the first fixing point is used to engage and fixate the article, the article is abutting the first surface. When using the second fixing point to engage the article, the article is abutting the second surface. The first and the second surfaces thus acting as support surfaces.

Preferably the end-effector body comprises a third fixing point facing away from the end-effector body in a third direction. Preferably the first fixing point is provided at a first surface, the second fixing point is provided at a second surface perpendicular to the first surface and the third fixing point is provided at an inclined third surface joining the first and the second surface. This way the first, the second and the third fixing points are facing away from the end-effector body in three different directions. By providing the end-effector body with three fixing points is achieved a compact and flexible end-effector body which can hold an article from three different directions without having to be tilted.

Suitably, the first fixing point and the third fixing point face away from the end-effector body in directions forming an angle there between, wherein the angle is between 30-90 degrees, preferably 45 degrees.

The third fixing point and the first fixing point are preferably arranged such that they face away from the end-effector body in directions intersecting each other at an angle between 30-90 degrees, preferably 45 degrees. Correspondingly, the first surface and the third surface are preferably arranged such that an angle is formed between the respective normal of the first and the third surface, wherein the angle is between 30-90 degrees, preferably 45 degrees. This way is achieved an end-effector body, which can engage with an article from three different directions without having to be tilted. The first surface and the third surface act as support surfaces when their respective fixing point is used to hold and fixate the article.

Preferably the third fixing point and the second fixing point are arranged such that they face away from the end-effector body in directions intersecting each other at an angle between 30-90 degrees, preferably 45 degrees. Correspondingly, the third surface and the second surface are preferably arranged such that an angle is formed between the respective normal of the third and the second surface, wherein the angle is between 30-90 degrees, preferably 45 degrees. This way is achieved an end-effector body, which can engage with an article from at least three different directions without having to be tilted.

Alternatively, the end-effector body is configured as a cube comprising five fixing points facing away from the end-effector body in five different directions intersecting each other at an angle about 90 degrees.

Suitably, the fixing points of the end-effector body are arranged to be utilized one at a time.

Preferably the fixing points comprise holes in the end-effector body. The holes are each provided on a surface of the end-effector body, which surfaces are angled in relation to each other. The arrangement of the surfaces results in the fixing points (holes) facing away from the end-effector body in different directions. The holes are preferably threaded.

Alternatively, the fixing points comprise threaded pins arranged on the end-effector body.

A fastening element is preferably arranged at the fixing point used for attachment to the article. The fastening element preferably comprises a nut and a bolt member, which bolt member is passed through the hole of the fixing point. Alternatively, the fastening element comprises a nut connecting with a threaded pin at the fixing point. This results in an easy and effective attachment of the end-effector body to the article. The end-effector body can thus easily be detached from the article and be moved to support the article from another position when needed.

The end-effector body is preferably generally C-shaped and thus comprises at least two parallel portions and one portion arranged perpendicularly to the two parallel portions. The end-effector thereby also comprises at least two outer surfaces, which are angled to each other and which preferably each comprise a fixing point. In cases where the fixing points comprise holes through the respective portion of the end-effector body, the C-shape makes it possible to reach the fixing points from two sides and it is thus easy to tighten fastening elements arranged at the fixing points. The C-shape also results in a low weight end-effector body, which is user-friendly.

The end-effector body preferably comprises a connection member for attachment to a support means, for example as a part of a fixture device. The support means may be a framework, a base frame, a stand, a workshop floor or similar. The support means preferably comprises adjustable legs joining a base plate and a top plate. The end-effector body is preferably arranged on the top plate. The legs are adjustable in that they are telescopic and the length of the legs can thus easily be changed. By changing the length of the legs, fine adjustments of the position of the end-effector body and the fixing points can be obtained. One fixing point of the end-effector body is preferably provided on a portion of the end-effector body that is parallel with the top plate of the support means.

Alternatively, the support means comprises one adjustable cylindrical column, with the end-effector body arranged on a top portion of the column.

The end-effector body preferably comprises Aluminium. This way is achieved a light weight end-effector tool.

Suitably, the end-effector body is, at the connection member to the support means, rotatable around an axis A. By rotating the end-effector body fine adjustments of the position of the end-effector body is achievable and an accurate attachment to the article can be obtained.

Preferably, the connection member is configured such that the end-effector body can be rotated and arranged at three fixed positions around the axis A.

Preferably, the first fixing point of the end-effector body is arranged coaxially with the connection member to the support means and thus the axis A.

This has also been achieved by an adjustable fixture device according to claim 12.

By providing an adjustable fixture device with the end-effector body according to the present invention, comprising at least a first and a second fixing point for attachment to an article, wherein the fixing points are arranged to face away from the end-effector body in different directions, the adjustable fixture device can hold the article from two different directions without having to be tilted. The adjustable fixture device can thereby be positioned in a steady position where it does not take up a lot of space. Thus is achieved an adjustable fixture device which is steady, has a high resistance and which is compact and space-saving.

This has also been achieved by a production line comprising the adjustable fixture according to claim 12.

By using adjustable fixture devices comprising end-effector bodies with fixing points in different directions in a production line, a flexible, effective and time-saving production line is achieved. Prior art fixture devices as described above needs to be tilted in order to hold and support an article from different directions. This means that the position of the legs of the fixture device may be essentially horizontal when holding an article from underneath, which results in an unsteady fixture. Also, when the legs are tilted in such a way, the fixture takes up a lot of space and may be in the way for the operators working on the article. This results in an ineffective and time consuming production line. By using adjustable fixture devices comprising end-effector bodies with fixing points in different directions, each fixture device can hold the article from a suitable direction without having to tilt the support means and thus is achieved a steady, reliable, effective and user-friendly production line.

### BRIEF DESCRIPTION OF THE DRAWINGS

The present invention will now be described by way of examples with references to the accompanying schematic drawings, of which:

FIG. 1 illustrates a prior art adjustable fixture device comprising an end-effector body;

FIG. 2a illustrates a side view of an end-effector body according to one embodiment of the invention;

FIG. 2b illustrates a side view of an end-effector body according to another embodiment of the invention;

FIG. 3a illustrates a side view of an end-effector body according to a further embodiment of the invention;

FIG. 3b illustrates another side view of the end-effector body according to FIG. 3a; and

FIG. 4a-b illustrates production lines adjustable fixture devices comprising end-effector bodies.

### DETAILED DESCRIPTION

Hereinafter, embodiments of the present invention will be described in detail with reference to the accompanying drawings, wherein for the sake of clarity and understanding of the invention some details of no importance are deleted.

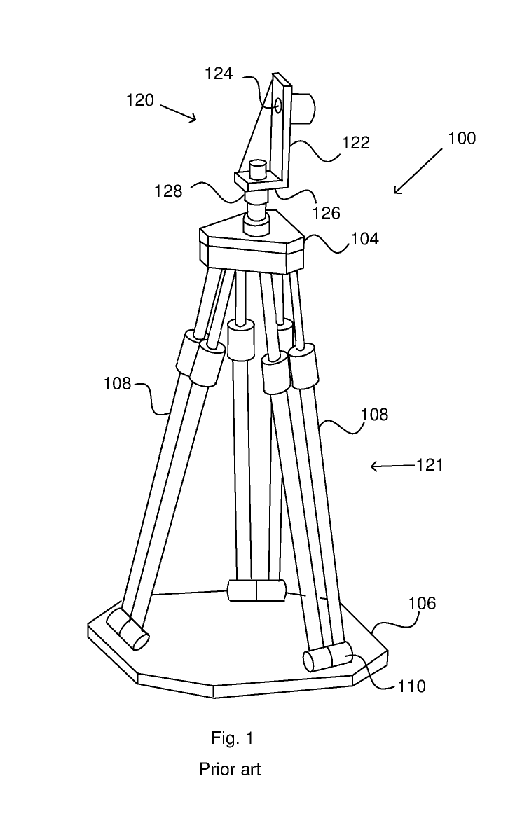

FIG. 1 shows an adjustable fixture device 100 according to prior art. The fixture device 100 comprises an end-effector body 120 and support means 121. The support means 121 comprises a top plate 104 and a base plate 106 and six legs 108 joining the top plate 104 and the base plate 106. The base plate 106 has a larger circumference than the top plate 104 and the legs 108 are thus inclined inwardly towards the top plate 104 when the fixture device 100 is positioned such that the top plate 104 and the base plate 106 are parallel. The legs 108 are telescopic and the leg 108 length can thus be changed. Each leg 108 also has a universal joint 110 in each end, which makes the fixture device 100 movable in all planes in the room. The end-effector body 120 is configured with an L-shape. The end-effector body 120 is further attached to the top plate 104 and is provided with a first portion 122, which is extending perpendicular to the plane of the top plate 104. The first portion 122 comprises a fixing joint 124 for attachment to an article (not shown). The end-effector body 120 also comprises a second portion 126, which is extending in parallel to the plane of the top plate 104 and which portion 126 comprises a connection member 128 for attachment to the top plate 104.

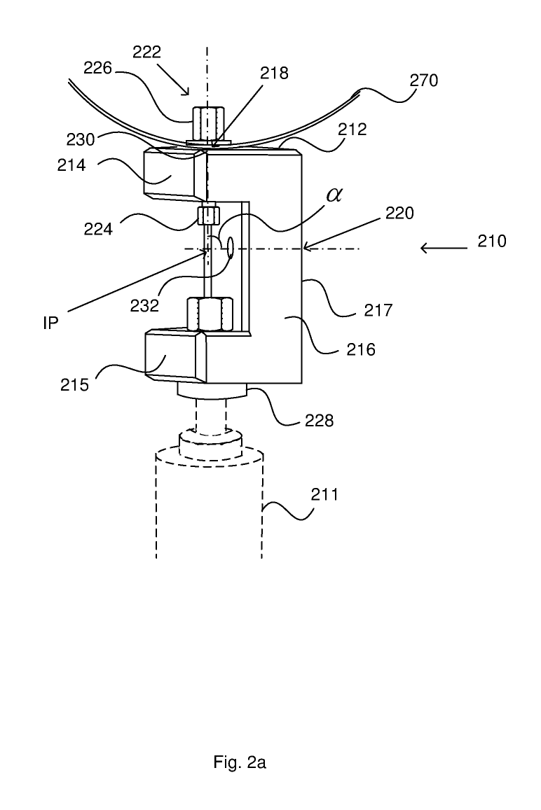

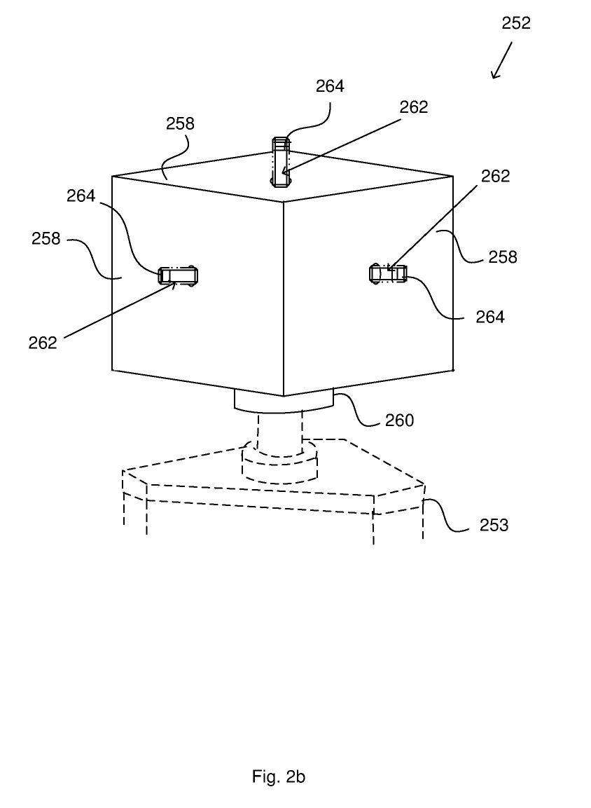

FIG. 2a illustrates an end-effector body 210 according to an embodiment of the invention. The end-effector body 210 is attached to a support means 211. The end-effector body 210 is configured with a C-shape and comprises a top portion 214 and a base portion 215, which are arranged in parallel to each other, and one web portion 216, which is extending perpendicularly to the top portion 214 and the base portion 215. The top portion 214 and the base portion 215 are parallel with a surface of the support means 211, to which the end-effector body 210 is attached. The top portion 214 of the end-effector body 210 comprises a first surface 212 and the web portion 216 comprises a second surface 217 extending perpendicularly to the first surface 212. A first fixing point 218 for attachment to an article 270 is provided at the first surface 212 and a second fixing point 220 is provided at the second surface 217. This way, the first and the second fixing points 218, 220 are facing away from the end-effector body 210 in two different directions (imagined lines) intersecting each other at an intersection point IP with an angle α, which is about 90 degrees. The fixing points 218, 220 comprise holes 230, 232 and a fastening element 222 is arranged at the fixing point 218, 220 which will be used to hold the article 270 (here illustrated at the first fixing point 218). The fastening element 222 comprises a nut 224 and a bolt member 226, which bolt 226 is passed through a hole in the article 270 and the hole 230, 232 of the fixing point 218, 220. The nut 224 is mounted on the bolt 226 and fixates the article 270 to the end-effector body 210. The first and the second surface 212, 217 are abutting the article 270 when their respective fixing point 218, 220 is being used to hold and fixate the article 270 and hence act as support surfaces. The base portion 215 of the end-effector body 210 comprises a connection member 228 for attachment to the support means 211. When the article 270 needs to be supported from underneath the first fixing point 218 of the end-effector body 210 may be used and when the article 270 needs to be supported from the side the second fixing point 220 may be used. This way, the same end-effector body 210 can be used to support articles 270 from two different directions when used at different positions, without having to tilt the end-effector body 210. This way is achieved an end-effector body 210, which is flexible.

FIG. 2b illustrates an end-effector body 252 according to another embodiment of the invention. The end-effector body 252 is attached to a support means 253. The end-effector body 252 is configured as a cube with six sides 258 where a bottom side 258 is attached to the support means 253 by a connection member 260. The other five sides 258 each comprises a fixing point 262 for attachment to an article (not shown). This way, the fixing points 262 are facing away from the end-effector body 252 in five different directions. The fixing points 262 comprise threaded pins 264 arranged to pass through a hole in the article. A fastening element such as a nut (not shown) mounted on the pin 264 is preferably used to fixate the article to the end-effector body 252.

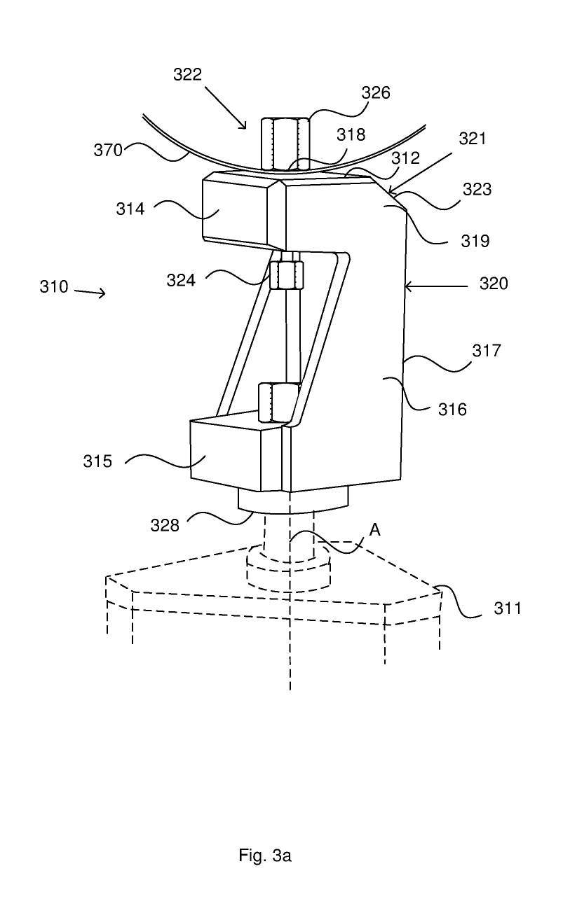

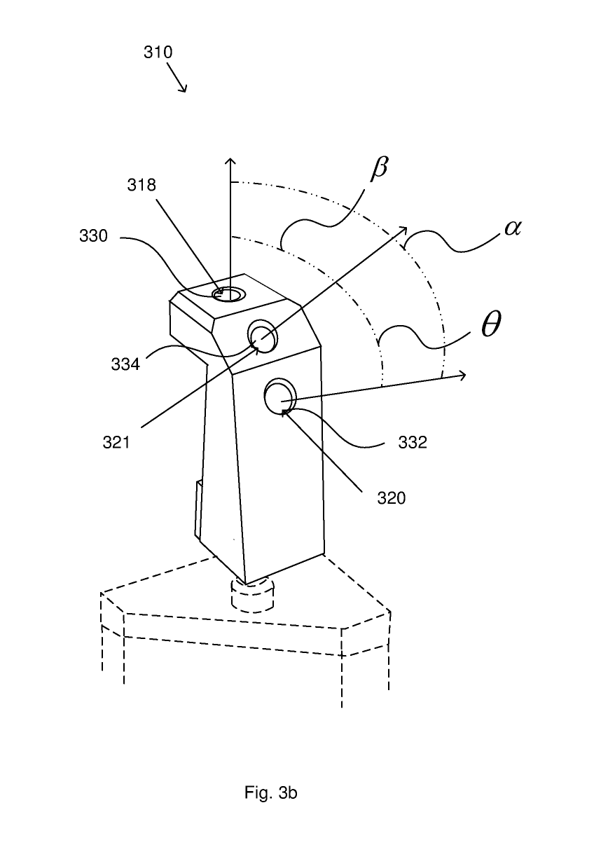

FIG. 3a shows an end-effector body for holding an aeronautical article 370 according to a further embodiment of the invention. The end-effector body 310 is attached to a support means 311. The end-effector body 310 is generally C-shaped and comprises a top portion 314 and a base portion 315 which are arranged in parallel to each other, a web portion 316 arranged perpendicularly to the top portion 314 and the base portion 315 and an inclined portion 319. The end-effector body 310 further comprises three fixing points 318, 320, 321 facing away from the end-effector body 310 in three different directions. The first fixing point 318 is provided at a first surface 312 on the top portion 314 of the end-effector body 310. The second fixing point 320 is provided at a second surface 317 on the web portion 316 extending perpendicularly to the first surface 312 and the third fixing point 321 is provided at an inclined third surface 323 on the inclined portion 319, joining the first and the second surface 312, 317. The inclined portion 319 thus joins the top portion 314 and the web portion 316. The fixing points 318, 320, 321 comprise holes 330, 332, 334 (seen in FIG. 3b) and a fastening element 322 is arranged at the fixing point 318, 320, 321 which will be used to hold the article 370 (here illustrated at the first fixing point 318). The fastening element 322 comprises a nut 324 and a bolt member 326, which bolt member 326 passes through a hole in the article 370 and through the hole 330, 332, 334 of the fixing point 318, 320, 321. The nut 324 is mounted on the bolt member 326 and fixates the article 370 to the end-effector body 310. The base portion 315 of the end-effector body 310 comprises a connection member 328 for attachment to the support means 311. Through the connection member 328 the end-effector body 310 is rotatable around an axis A. The first fixing point 318 is preferably arranged coaxially with the connection member 328 and thus the axis A.

FIG. 3b shows another side view of the end-effector body 310 illustrated in FIG. 3a and illustrates the first fixing point 318 comprising a first hole 330, the second fixing point 320 comprising a second hole 332 and the third fixing point 321 comprising a third hole 334. The third surface 323 and the first surface 312 are arranged such that an angle β is formed between the normal of the first surface 312 and the normal of the third surface 323. This way, the first fixing point 318 and the third fixing point 321 are facing away from the end-effector body 310 in directions intersecting each other at the angle β. The angle β is about 45 degrees. The second surface 317 is arranged such that an angle θ is formed between the normal of the second surface 317 and the normal of the third surface 323. This way, the second fixing point 320 and the third fixing point 321 are facing away from the end-effector body 310 in directions intersecting each other at an angle θ. The angle θ is about 45 degrees. The first fixing point 318 and the second fixing point 320 are thus facing away from the end-effector body 310 in directions intersecting each other at an angle α, which is about 90 degrees.

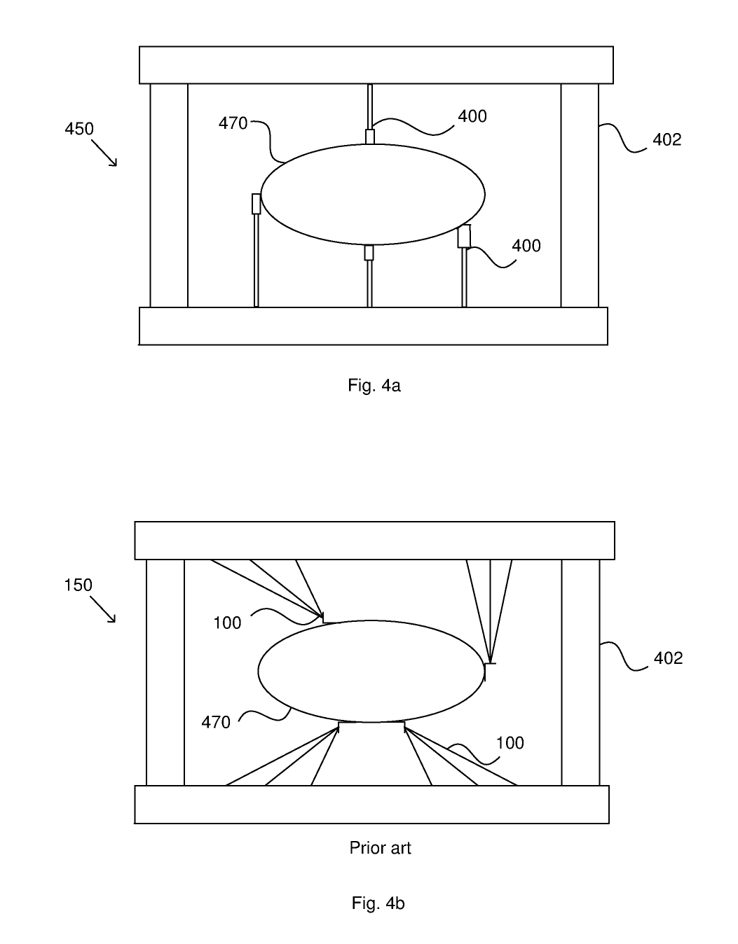

FIG. 4a shows a schematic view of a production line 450 with adjustable fixture devices 400 comprising end-effector bodies 210, 252, 310 for holding an article 470 according to an aspect of the invention. The production line 450 comprises a framework 402 and a plurality of adjustable fixture devices 400 attached to the framework 402. The adjustable fixture devices 400 further comprise support means 211, 253, 311, to which the end-effector bodies 210, 252, 310 are attached. The end-effector bodies 210, 252, 310 of the adjustable fixture devices 400 are configured as any of the end-effector bodies 210, 252, 310 described in FIG. 2a-3b. Each end-effector body 210, 252, 310 comprises at least two fixing points 218, 220, 262, 318, 320, 321 facing away from the end-effector body 210, 252, 310 in two different directions. This way, the article 470 can be held from underneath, from above or from the side without having to tilt the end-effector body 210, 252, 310, and thus without having to tilt the support means 211, 253, 311 of the fixture devices 400. This results in a flexible, steady and compact fixture device 400 and thus a reliable and flexible production line 450 where fixture devices 400 can be detached and moved when not needed. FIG. 4b shows a production line 150 comprising adjustable fixture devices 100 according to the prior art described in FIG. 1. Herein, the legs 108 of the fixture device 100 have to be tilted in order to get the fixing point 124 of the end-effector body 210 aligned with the article 470. This results in an unsteady fixture device 100 which takes up a lot of space, and thus a production line 150 which is ineffective and time consuming.

The present invention is of course not in any way restricted to the preferred embodiments described above, but many possibilities to modifications, or combinations of the described embodiments, thereof should be apparent to a person with ordinary skill in the art without departing from the basic idea of the invention as being defined in the appended claims. The end-effector body may comprise more than three fixing points and the fixing points may face away from the end-effector body in respective directions forming any angle between 0-90 degrees there between. The definition of a direction, in which the respective fixing points face away from the end-effector body, is an imagined straight line. The end-effector may be attached to any type of support means. The fixing points may comprise regular holes, threaded holes, threaded pins, hooks or any other type of attachment means. The fastening element used to fixate the end-effector body to the article may comprise bolts, nuts, rivets, nails, clamps or similar. Further, the term “end-effector body” is considered to encompass all different expressions for a part used on a fixture device, which part is attached to the article to be held. The provided fixing points on the end-effector body are preferably utilized one at a time, however, it is possible to use more than one fixing point at a time, for example when supporting two different articles at the same time. The base portion of the end-effector body is defined as the portion of the end-effector body that is arranged closest to the support means. The top portion of the end-effector body is defined as the portion of the end-effector body that is arranged away from the support means.

1. An end-effector body for a fixture device for aeronautical industry, the end-effector body comprising:
a first fixing point, a second fixing point and a third fixing point for attachment to an article, wherein the fixing points are arranged to face away from the end-effector body in different directions, characterized in that wherein the first fixing point is provided at a first surface, the second fixing point is provided at a second surface perpendicular to the first surface and the third fixing point is provided at an inclined third surface joining the first surface and the second surface.

2. The end-effector body according to claim 1, wherein the first fixing point and the second fixing points point face away from the end-effector body in directions forming an angle therebetween.

3. The end-effector body according to claim 1, wherein the first fixing point and the third fixing point face away from the end-effector body in directions forming an angle therebetween.

4. The end-effector body according to claim 1, wherein at least one fixing point comprises a hole in the end-effector body.

5. The end-effector body according to claim 1, further comprising:
a fastening element arranged at least at one fixing point for attachment of the end-effector body to the article.

6. The end-effector body according to claim 5, wherein the fastening element comprises a nut and a bolt member.

7. The end-effector body according to claim 1, wherein the end-effector body is generally C-shaped.

8. The end-effector body according to claim 1, wherein the end-effector body comprises aluminum.

9. The end-effector body according to claim 1, wherein the end-effector body is rotatable around an axis.

10. An adjustable fixture device for aeronautical industry for holding an article, the fixture device comprising:
an end-effector body comprising a first fixing point, a second fixing point and a third fixing point for attachment to an article, wherein the fixing points are arranged to face away from the end-effector body in different directions, wherein the first fixing point is provided at a first surface, the second fixing point is provided at a second surface perpendicular to the first surface and the third fixing point is provided at an inclined third surface joining the first surface and the second surface.

11. A production line, comprising:
a fixture device comprising an end-effector body comprising a first fixing point, a second fixing point and a third fixing point for attachment to an article, wherein the fixing points are arranged to face away from the end-effector body in different directions, wherein the first fixing point is provided at a first surface, the second fixing point is provided at a second surface perpendicular to the first surface and the third fixing point is provided at an inclined third surface joining the first surface and the second surface.

12. The end-effector body according to claim 2, wherein the angle is about 90 degrees.

13. The end-effector body according to claim 3, wherein the angle is about 45 degrees.
